(19) United States
(12) Patent Application Publication
(10) Pub. No.: US 2003/0133299 A1
(43) Pub. Date: Jul. 17, 2003

(54) Illuminating module for a display apparatus

(75) Inventor: Fu-Ming Chuang, Chu-Tung Chen (TW)

Correspondence Address: VINSON & ELKINS L.L.P., 1001 FANNIN STREET, 2300 FIRST CITY TOWER, HOUSTON, TX, 77002-6760, US

(73) Assignee: Pokia Technology Co., Ltd., Hsin-Shih Hsiang (TW)

(21) Appl. No.: 10/050,657

(22) Filed: Jan. 16, 2002

(51) Int. Cl. F21V 7/00

(52) U.S. Cl. 362/296; 362/346

(57) ABSTRACT

An illuminating module is adapted for use in a display apparatus, and includes a spherical first reflector segment having a first reflecting surface and a first focal point. A parabolic second reflector segments has a second reflecting surface facing the first reflecting surface in a first direction, and a second focal point that is coincident with the first focal point. A light source is coincident with the first and second focal points. Light rays that radiate toward the second reflecting surface are reflected thereby to travel in a second direction transverse to the first direction. Light rays that radiate toward the first reflecting surface are reflected thereby back to the light source. A third reflector segment has a third reflecting surface facing the second reflecting surface in the second direction to reflect the light rays received thereby to travel in a third direction transverse to the second direction.

### BACKGROUND OF THE INVENTION

1. Field of the Invention

The invention relates to an illuminating module for a display apparatus, more particularly to an illuminating module that includes a reflector assembly having two parabolic reflector segments to achieve a higher light utilization rate.

2. Description of the Related Art

Conventional display apparatuses process light from a light source by performing beam splitting, modulation, synthesis, image formation, etc. The utilization of light has a direct effect on the quality of the images produced and the size of the apparatus. A conventional illuminating module 1 for a display apparatus is shown in FIG. 1, and includes, from left to right, a parabolic reflector 11, a light source 12, a light integrator 13, a polarization state converter 14, and two condensers 15. The parabolic reflector 11 has a parabolic reflecting surface 111 facing the light source 12. The reflecting surface 111 confines an opening 112 oriented to the right. The light source 12 is disposed on a focal point of the parabolic reflector 11. Light rays radiated by the light source 12 are initially directed to the reflecting surface 111 and are then reflected thereby to travel in parallel lines toward the light integrator 13, which integrates the light rays into evenly distributed light rays. The light rays then pass through the polarization state converter 14 and are condensed by the condensers 15 before being projected on a display panel 16 for displaying desired images.

In the conventional illuminating module 1, although the parabolic reflector 11 can reflect the light rays from the light source 12, in order to achieve an optimum light utilization rate, the size of the parabolic reflector 11 must be sufficient to encompass or surround the light source 12. That is, as illustrated in FIG. 1, the parabolic reflector 11 encompasses the light source 12 such that the reflected light rays travel in parallel lines toward the light integrator 13. Due to the relatively large size of the parabolic reflector 11, the light integrator 13 has to be correspondingly enlarged. Besides, to enable the light rays from the light source 12 to project effectively on the display panel 16, which has a relatively small size, a number of condensers 15 have to be disposed between the light integrator 13 and the display panel 16. In other words, although the conventional illuminating module 1 is capable of converting the reflected light rays into parallel light rays by means of the parabolic reflector 11, due to the long arc length of the reflecting surface 111 of the parabolic reflector 11, to avoid waste of light resources, the sizes of the light integrator 13 and the polarization state converter 14 have to be correspondingly increased so as to achieve the desired light convergence. Therefore, to effectively utilize the light rays, the sizes and the number of the components of the conventional illuminating module 1 are relatively large, which goes against the current trend for compact and light products.

On the other hand, if a smaller light integrator 13 and a fewer number of condensers 15 are used for the sake of compactness, due to the extensive area covered by the light rays reflected by the parabolic reflector 11, the light integrator 13 cannot effectively receive the light rays from the light source 12, thereby resulting in poor light utilization. In short, the conventional illuminating module 1 cannot achieve compactness with an optimum light utilization rate.

### SUMMARY OF THE INVENTION

Therefore, the main object of the present invention is to provide an illuminating module for a display apparatus, which can effectively reduce the size and weight of the display apparatus and which includes a reflector assembly having two parabolic reflector segments.

Accordingly, an illuminating module of the present invention is adapted for use in a display apparatus, and includes a spherical first reflector segment, parabolic second and third reflector segments, and a light source. The first reflector segment has a curved first reflecting surface and a first focal point. The second reflector segment has a curved second reflecting surface that faces and that is spaced apart from the first reflecting surface in a first direction, and a second focal point that is coincident with the first focal point. The light source is coincident with the first and second focal points. A first portion of light rays from the light source radiates toward the second reflecting surface, and is reflected by the second reflecting surface to travel in a second direction transverse to the first direction. A second portion of the light rays from the light source initially radiates toward the first reflecting surface, and is subsequently reflected by the first reflecting surface back to the light source so as to combine with the first portion of the light rays. The third reflector segment has a curved third reflecting surface that faces and that is spaced apart from the second reflecting surface in the second direction. The third reflecting surface receives the light rays reflected by the second reflecting surface and reflects the light rays received thereby to travel in a third direction transverse to the second direction.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional illuminating module for a display apparatus;

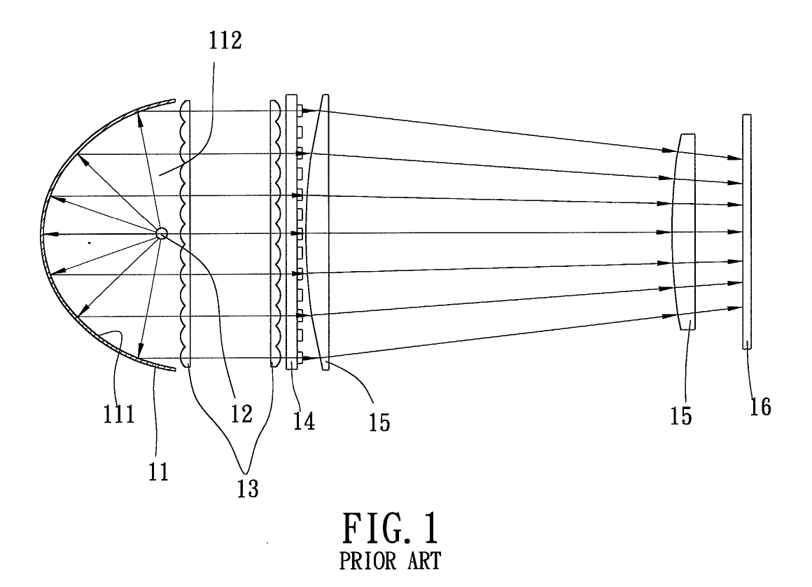

FIG. 2 is a schematic view of the first preferred embodiment of an illuminating module for a display apparatus according to the invention; and

FIG. 3 is a schematic view of the second preferred embodiment of an illuminating module for a display apparatus according to the invention.

### DETAILED DESCRIPTION OF THE PREFERRED EMBODIMENTS

Before the present invention is described in greater detail, it should be noted that like elements are denoted by the same reference numerals throughout the disclosure.

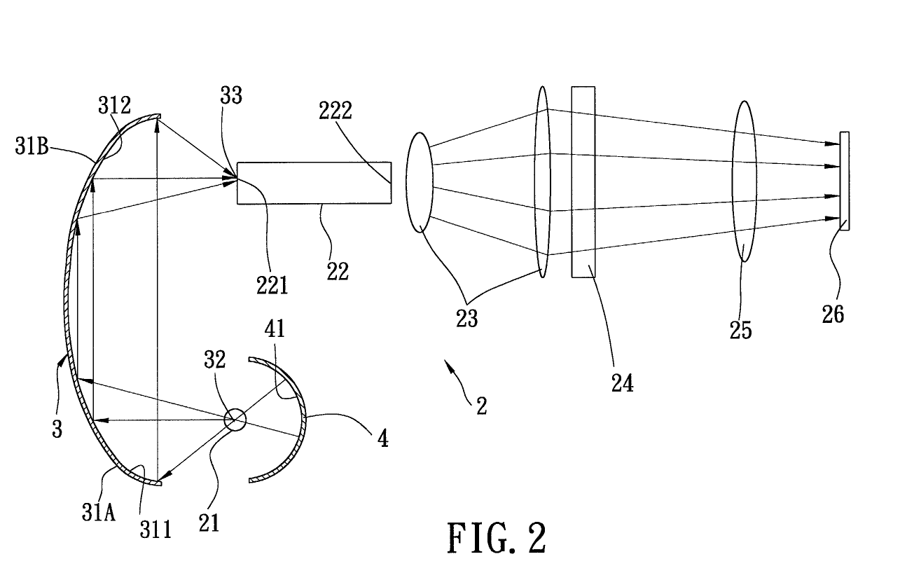

Referring to FIG. 2, the first preferred embodiment of an illuminating module 2 according to the present invention forms a part of a display apparatus, and is shown to include a spherical first reflector segment 4, a reflector assembly 3, a light source 21, a light integrator 22, a lens unit 23, a polarization state converter 24, and a condenser set 25.

The light source 21 can be a light-radiating article in any form which is capable of generating light rays and which can be used singly or in combination.

The spherical first reflector segment 4 has a curved first reflecting surface 41 and a first focal point, and is disposed adjacent to the light source 21.

The reflector assembly includes parabolic second and third reflector segments 31A, 31B. The second reflector segment 31A has a curved second reflecting surface 311 that faces and that is spaced apart from the first reflecting surface 41 in a first direction, and a second focal point 32 that is coincident with the first focal point. The third reflector segment 31B has a curved third reflecting surface 312 that faces and that is spaced apart from the second reflecting surface 311 in a second direction transverse to the first direction, and a third focal point 33. The light source 21 is disposed at and is coincident with the first focal point and the second focal point 32. When light rays emitted from the light source 21 radiate toward the second reflecting surface 311, since the light source 21 is located at the second focal point 32 of the second reflector segment 31A, the light rays are reflected by the second reflecting surface 311 to travel in parallel lines in the second direction toward the third reflecting surface 312. The third reflecting surface 312 receives the light rays reflected by the second reflecting surface 311 and reflects the same to travel in a third direction transverse to the second direction for subsequent convergence at the third focal point 33. The light rays which radiate toward the first reflecting surface 41 are reflected thereby back to the light source 21 and further to the second reflecting surface 311 for subsequent reflection in parallel lines to the third reflecting surface 312. In this embodiment, the third reflector segment 31B is disposed above and is connected to the second reflector segment 31A such that the third and second (first) focal points 33, 32 are aligned in a fourth direction parallel to the second direction.

The light integrator 22 is spaced apart from the third reflecting surface 312 in the third direction so as to receive the light rays from the third reflecting surface 312. The light integrator 22 is in the form of a glass rod integrator, or a hollow pipe with an inner wall surface plated with a reflective film, and has an input side 221 and an output side 221. The input side 221 is coincident with the third focal point 33 for receiving the light rays that converge at the third focal point 33. The light integrator 22 converts the light rays received thereby into evenly distributed light rays for output via the output side 222.

The lens unit 23 is disposed to receive the light rays from the output side 222 of the light integrator 22. The lens unit 23 may include a single positive lens or a combination of lenses. In this embodiment, a couple of lenses are provided.

The polarization state converter 24 is disposed to receive the light rays passing through the lens unit 23 for converting the polarization state of the light rays passing therethrough from P-polarization to S-polarization, or vice versa, in a known manner so as to facilitate effective utilization of the light rays.

The condenser set 25 is disposed to receive the light rays from the polarization state converter 24 and is adapted to project the light rays on a display panel 26 for displaying desired images thereon. The condenser set 25 is in the form of a positive lens set, and the number of condenser lenses in the condenser set 25 can vary as desired. In this embodiment, one condenser lens is sufficient to achieve the intended object. The third reflector segment 31B, the light integrator 22, the lens unit 23, the polarization state converter 24, and the condenser 25 are aligned in the third direction.

In this embodiment, when the light source 21 radiates light rays, a first portion of the light rays will radiate toward the second reflecting surface 311 and will be reflected thereby to travel in parallel lines toward the third reflecting surface 312 along the second direction for subsequent reflection by the third reflecting surface 312 to travel in the third direction for convergence at the input side 221 of the light integrator 22, whereas a second portion of the light rays which radiates toward the first reflecting surface 41 will be initially reflected by the first reflecting surface 41 back to the light source 21 and further back to the second reflecting surface 311, which directs the light rays to the third reflecting surface 312 in parallel lines for subsequent convergence at the input side 221 of the light integrator 22. The light integrator 22 integrates the combined first and second portions of the light rays into evenly distributed light rays for passage through the lens unit 23 and the polarization state converter 24. The latter converts the light rays into the desired polarization state for passage through the condenser set 25. The light rays are converged by the condenser set 25 so that the area encompassed thereby can be reduced for subsequent projection on the display panel 26. In other words, this embodiment employs the light integrator 22 that is spacedly aligned with the third reflecting surface 312 of the third reflector segment 31B in the third direction in combination with the first reflector segment 4 that is spacedly aligned with the second reflector surface 311 of the second reflector segment 31A to reduce the area encompassed by the light rays from the reflector assembly 3, thereby enabling a reduction in the size of the display apparatus.

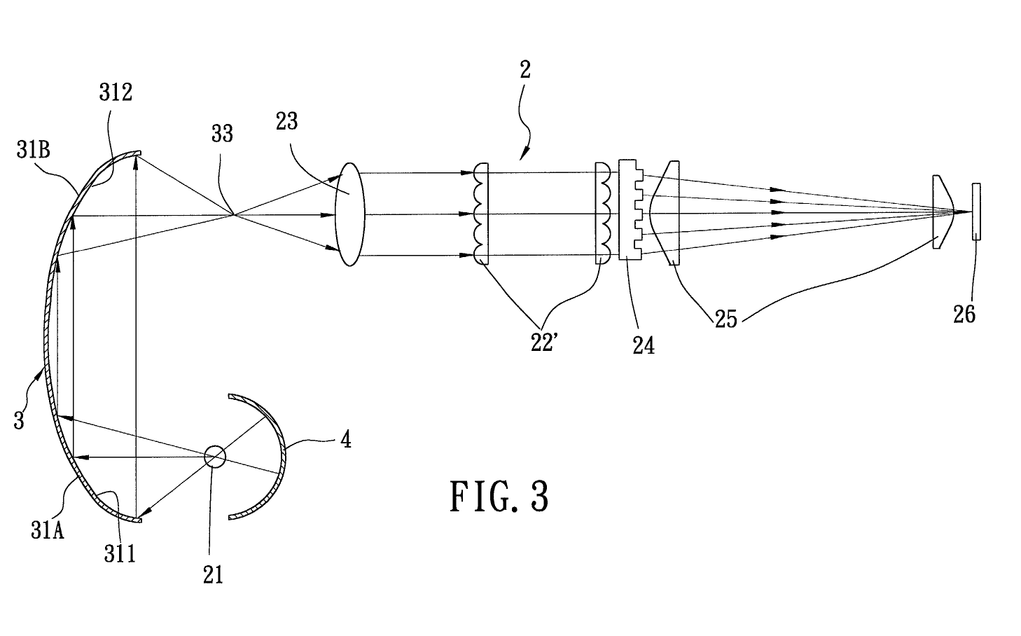

Referring to FIG. 3, the second preferred embodiment of an illuminating module 2 according to the present invention is shown to include a spherical first reflector segment 4, a reflector assembly 3, a light source 21, a light integrator 22′, a lens unit 23, a polarization state converter 24, and a condenser set 25 comprising two condenser lenses. As the relative relationships among the light source 21, the reflector assembly 3, the first reflector segment 4 and the condenser set 25 are the same as those in the previous embodiment, a detailed description thereof is dispensed with herein for the sake of brevity. In this embodiment, the light integrator 22′ includes first and second integrator lenses that form a lens array integrator, and has substantially the same function as the light integrator 22 in the previous embodiment, i.e., converting the light rays passing therethrough into evenly distributed light rays. Another difference between this embodiment and the previous embodiment resides in that the lens unit 23, which includes a single lens, is disposed between the third reflecting surface 312 and the light integrator 22′, and has a fourth focal point that is coincident with the third focal point 33 and that is disposed between the third reflecting surface 312 and the lens unit 23. The lens unit 23 directs the light rays that diverge from the third focal point 33 toward the light integrator 22′. By changing the relative positions of the light integrator 22′ and the lens unit 23, the area covered by the light rays from the reflector assembly 3 can be likewise reduced prior to projection of the light rays on the display panel 26.

From the above description, it can be appreciated that the present invention utilizes the combination of a spherical first reflector segment 4 and a reflector assembly 3 which includes a parabolic second reflector segment 31A that has a second focal point coincident with the first focal point of the first reflector segment 4 and a light source 21, and a parabolic third reflector segment 31B that faces and that is aligned with a light integrator 22 and the relevant components, to effectively reflect and project the light rays from the light source 21 and to reduce the area covered by the light rays. Furthermore, as light rays from the reflector assembly 3 are converged at the third focal point 33, the sizes of the relevant components can be reduced. In other words, as compared with the conventional illuminating module described hereinbefore, under the condition that the light utilization rate is the same, the sizes of the components of the display apparatus can be reduced for compactness. On the other hand, under the condition that the illuminating module of the present invention and the conventional illuminating module have the same size, the present invention can achieve a comparatively higher light utilization rate.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An illuminating module for a display apparatus, said illuminating module comprising:
a spherical first reflector segment having a curved first reflecting surface and a first focal point;
a parabolic second reflector segment having a curved second reflecting surface that faces and that is spaced apart from said first reflecting surface in a first direction, and a second focal point that is coincident with said first focal point;
a light source coincident with said first and second focal points, wherein a first portion of light rays from said light source radiates toward said second reflecting surface and is reflected by said second reflecting surface to travel in a second direction transverse to the first direction, and wherein a second portion of the light rays from said light source initially radiates toward said first reflecting surface and is subsequently reflected by said first reflecting surface back to said light source so as to combine with the first portion of the light rays; and
a parabolic third reflector segment having a curved third reflecting surface that faces and that is spaced apart from said second reflecting surface in the second direction, said third reflecting surface receiving the light rays reflected by said second reflecting surface and reflecting the light rays received thereby to travel in a third direction transverse to the second direction.

2. The illuminating module of claim 1, further comprising:
a light integrator spaced apart from said third reflecting surface in the third direction so as to receive the light rays from said third reflecting surface; and
a condenser spaced apart from said light integrator in the third direction so as to receive the light rays passing through said light integrator.

3. The illuminating module of claim 2, wherein said third reflector segment has a third focal point, said light integrator being a rod integrator with an input side that is coincident with said third focal point.

4. The illuminating module of claim 3, further comprising a lens unit disposed between said light integrator and said condenser.

5. The illuminating module of claim 4, wherein said lens unit is a positive lens unit.

6. The illuminating module of claim 3, wherein said first and third focal points are aligned in a fourth direction parallel to the second direction.

7. The illuminating module of claim 2, further comprising a polarization state converter disposed between said light integrator and said condenser.

8. The illuminating module of claim 2, wherein said light integrator is a lens array integrator.

9. The illuminating module of claim 8, wherein said third reflector segment has a third focal point, said illuminating module further comprising a lens unit disposed between said third reflecting surface and said light integrator, said lens unit having a fourth focal point that is coincident with said third focal point and that is disposed between said third reflecting surface and said lens unit, said lens unit directing the light rays that diverge from said third focal point toward said light integrator.

10. The illuminating module of claim 1, wherein said third reflector segment is connected to said second reflector segment.
